(19) United States
(12) Patent Application Publication
(10) Pub. No.: US 2004/0036825 A1
(43) Pub. Date: Feb. 26, 2004

(54) Reflector and reflective liquid crystal display device provided with the reflector

(75) Inventor: Katsumasa Yoshii, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/642,253

(22) Filed: Aug. 14, 2003

(30) Foreign Application Priority Data
Aug. 23, 2002 (JP) 2002-243686

(51) Int. Cl. G02F 1/1335

(52) U.S. Cl. 349/113

(57) ABSTRACT

A reflector is provided which has viewing angle properties that when the reflected light of the light having entered the reflector is observed from the direction close to the normal direction to the reflector, it can be seen brighter than seen from the other viewing angles. A reflector includes a plurality of concave parts formed on the surface of a base material, wherein the inner surface of the concave part is formed of a surface that a peripheral curved surface being a part of aspheric surface is continued to a plane at a position surrounded by the peripheral curved surface; each of the plurality of the concave parts has a specified longitudinal section passing through a deepest point of the concave part; the form of the inner surface of the specified longitudinal section is formed of a first curve from one peripheral part of the concave part to the deepest point, a second curve from the deepest point to a first straight line continuously to the first curve, the first straight line to a third curve continuously to the second curve, and the third curve to an other peripheral part continuously to the first straight line; a curvature radius of the second curve is greater than a curvature radius of the first curve; and curvature radii of the second curve and the third curve are equal.

### BACKGROUND OF THE INVENTION

1. Field of the Invention

The present invention relates to a reflector and a reflective liquid crystal display device provided with the reflector.

2. Description of the Related Art

Generally, in the display form of liquid crystal display devices, there are devices called a semi-transmissive type and a transmissive type having a backlight, and a device called a reflective type. The reflective liquid crystal display device is a liquid crystal display device that utilizes only outside light such as sunlight and luminous light with no backlight, which is often used in a personal digital assistant required to be low profile, light weight, and low power consumption, for example. In addition, the semi-transmissive liquid crystal display device is that turns on the backlight and operates in a transmissive mode under an environment where outside light cannot be obtained sufficiently, and operates in a reflective mode without turning on the backlight when outside light can be obtained sufficiently, which is often used in portable electronic devices such as a cellular phone and a notebook personal computer (notebook PC).

As the traditional reflective liquid crystal display device, a device is known that a specular reflector using an Al film is provided on the inner side or outer side of a liquid crystal cell of a reflective mode STN (Super-Twisted Nematic) system.

When the reflective liquid crystal display device described above is assembled in a device where a display surface is used obliquely as the personal digital assistant such as the cellular phone and the notebook PC, the device is generally seen from the directions close to a normal direction H to the liquid crystal display device in many cases, as shown in FIG. 10. More specifically, an angle θ which a main observation direction α of an observer (user) seeing a display surface (screen) forms with the normal direction H often ranges from angles of 0 to 20 degrees.

FIG. 10 is an explanatory diagram illustrating a state where a cellular phone is used in which a display part 100 formed of the reflective liquid crystal display device is provided in a main body 105. In FIG. 10, H is the normal to the liquid crystal display device provided in the display part 100, Q is the incident light, and ω₀ is the incident angle (30 degrees, for example). Additionally, R₁₁ is the reflected light (direct reflection) where the incident angle ω₀ is equal to a reflection angle ω, R₁₂ is the reflected light where the reflection angle ω is smaller than the incident angle ω₀, and R₁₃ is the reflected light where the reflection angle ω is greater than the incident angle ω₀.

As apparent from the drawing, an observer's viewpoint ob generally gathers in the direction of the reflected light R₁₂ close to the normal direction H, more specifically, in the direction ranging from the normal direction H to an angle of 10 degrees. On the other hand, the reflected lights R₁₁ and R₁₃ are hard to see because they are in the direction where the display surface is seen from below. Therefore, considering the convenience of the use of the observer, it is desired to secure a wide viewing angle as well as to increase the reflectance in the direction of a smaller reflection angle than the direct reflection.

However, in the traditional reflective liquid crystal display device provided with the specular reflector using the Al film, almost all of the incident light is reflected in the direction of direct reflection and the neighborhood directions (the peak of the reflectance is at an angle of direct reflection and neighborhood angles of the direct reflection). Thus, the display seen from the direction of direct reflection and the neighborhood directions is seen bright but the display seen from the other directions is seen dark.

Therefore, when the display surface of the cellular phone having the traditional reflective display device provided in the display part is seen, the observer's viewpoint generally gathers in the directions close to the normal direction H as described above. Thus, the display is dark, and the observer has to see the display from the direction of direct reflection and the neighborhood directions when trying to see bright display, which is hard to see because the observer looks up the display surface from below.

Then, in order to improve such the problem, a reflective liquid crystal display device shown in FIG. 11 is considered.

The reflective liquid crystal display device has the schematic configuration in which a first retardation plate 173a, a second retardation plate 173b and a polarizing plate 174 are sequentially layered on an upper glass substrate 182 on a liquid crystal cell 172 of a reflective mode STN (Super-Twisted Nematic) system.

The liquid crystal cell 172 has the schematic configuration in which a lower glass substrate 175, a reflector 171, an overcoat layer 177c, a color filter 176, an overcoat layer 177a, a lower transparent electrode layer 178, a lower alignment layer 179, an upper alignment layer 180 facing the lower alignment layer 179 with space, a top coat layer 177b, an upper transparent electrode layer 181 and the upper glass substrate 182 are sequentially layered.

In the reflector 171, a plurality of concave parts 171e is formed irregularly and adjacently on a surface (reference plane) Sa of a flat plate shaped base material 171a made of aluminium.

The form of the inner surface in the specified longitudinal section of the concave part 171e is formed of a first curve a from one peripheral part S_{b1} to a deepest point D₂ of the concave part 171e, and a second curve b from the deepest point D₂ to an other peripheral part S_{b2} of the concave part continuously from the first curve a. The first and second curves a and b have a tilt angle of zero degree to the base material surface Sa at a deepest point D₂, joining each other. The size of the curvature radius of the first curve a is set smaller than the curvature radius of the second curve b.

In such the reflective liquid crystal display device, the thickness of the base material 171a is reduced to allow the device to be used as the semi-transparent reflective liquid crystal display device in which the light emitted from under the liquid crystal cell 172 is transmissive through the base material 171a. In this case, a backlight is provided on the under side of the liquid crystal cell 172 as a light source.

### SUMMARY OF THE INVENTION

However, in the reflective liquid crystal display device provided with the reflector 171 described above, the reflectance in the directions of smaller reflection angles than the direct reflection angle (the directions closer to the normal direction than the direct reflection angle) can be increased more slightly than in the device provided with the specular reflector using the Al film, but there is an increasing demand in recent years to obtain brighter display and to further improve display properties. It is difficult to realize the demand by the reflective liquid crystal display device shown in FIG. 11.

The invention has been made to solve the problems. One object is to provide a reflector having viewing angle properties that when the reflected light of the light having entered the reflector is observed from the direction close to the normal direction to the reflector, it is seen brighter than seen from the other viewing angles.

In addition, one object of the invention is to provide a reflective liquid crystal display device having viewing angle properties that when display is observed from the direction close to the normal direction to the reflective liquid crystal display device, it is seen brighter than seen form the other viewing angles.

In order to achieve the objects, a reflector of the invention is characterized by including a plurality of concave parts having light reflectivity formed on a metal film formed on a base material or on a surface of the base material,

wherein an inner surface of the concave part is formed of a surface that a peripheral curved surface being a part of aspheric surface is continued to a plane at a position surrounded by the peripheral curved surface,

each of the plurality of the concave parts has a specified longitudinal section passing through a deepest point of the concave part,

a form of an inner surface of the specified longitudinal section is formed of a first curve from one peripheral part of the concave part to a deepest point thereof, a second curve from the deepest point of the concave part to a first straight line continuously to the first curve, the first straight line to a third curve continuously to the second curve, and the third curve to an other peripheral part continuously to the first straight line,

a curvature radius of the second curve is greater than a curvature radius of the first curve, and

curvature radii of the second curve and the third curve are equal.

According to the reflector in the configuration, the curvature radii of the first to third curves, the position of the plane, the tilt angle of the first straight line, and the pitch and depth of the plurality of the concave parts are changed, thereby allowing the reflector to be easily controlled to have viewing angle properties that can be seen brighter than seen from the other viewing angles when observed from the direction close to the normal direction to the reflector.

A reflector of the invention is characterized by including a plurality of concave parts having light reflectivity formed on a metal film formed on a base material or on a surface of the base material,

wherein an inner surface of the concave part is formed of a surface that a peripheral curved surface being a part of spherical surface is continued to a plane at a position surrounded by the peripheral curved surface,

each of the plurality of the concave parts has a specified longitudinal section passing through a deepest point of the concave part,

a form of an inner surface of the specified longitudinal section is formed of a first curve from one peripheral part of the concave part through a deepest point thereof to a first straight line, the first straight line to a second curve continuously to the first curve, and the second curve to an other peripheral part continuously to the first straight line, and

curvature radii of the first curve and the second curve are equal.

According to the reflector in the configuration, the curvature radii of the first and second curves, the position of the plane, the tilt angle of the first straight line, and the pitch and depth of the plurality of the concave parts are changed, thereby allowing the reflector to be easily controlled to have viewing angle properties that can be seen brighter than seen from the other viewing angles when observed from the direction close to the normal direction to the reflector.

In the reflector of the invention, each of the plurality of the concave parts is preferably formed so as to align the specified longitudinal section in the same direction, and to orient the first straight line in a single direction.

In the reflector of the invention, it is acceptable that the form of the plane is a rectangular shape or arc shape seen in plan. It is fine that the plane is formed inside the concave part so as to be linesymmetric to a line passing through the specified longitudinal section. In addition, it is acceptable that the plane is formed inside the concave part so as to be non-linesymmetric to a line passing through the specified longitudinal section. In the reflector of the invention, as the plurality of the concave parts, it is fine that that having the plane linesymmetric to the line passing through the specified longitudinal section and that having the plane non-linesymmetric to the line passing through the specified longitudinal section are mixed.

In the reflector of the invention, it is acceptable that the depth of the concave part is formed irregularly in the range of 0.1 to 3 μm, and the pitch between the adjacent concave parts is disposed irregularly in the range of 2 to 50 μm in the plurality of the concave parts.

In the reflector of the invention, it is fine that the peripheral curved surface being a part of the spherical surface is formed to have a tilt angle distribution in the range of −35 to +35 degrees.

Additionally, in the reflector of the invention, the reflector preferably has a reflectance distribution asymmetric to a direct reflection angle of incident light, and also has a non-Gaussian distribution type reflectance property where the maximum value of the reflectance is in the range of a reflection angle smaller than the direct reflection angle of the incident light by changing the curvature radii of the first to third curves, the position of the plane, the tilt angle of the first straight line, and the pitch and depth of the plurality of the concave parts.

According to the reflector in the configuration, the reflectance in the range of a specific angle within the reflection angle smaller than the direct reflection angle is increased. The reflector having high luminance can be obtained particularly at angles of 0 to 20 degrees which the normal direction of the reflector forms with the main observation direction in the practical viewpoint. When such the reflector is provided in a liquid crystal display device, bright display (screen) can be obtained, and a reflective liquid crystal display device excellent in display properties can be realized.

Furthermore, preferably, a profile of a graph illustrating the reflectance distribution of the reflector is stepped, and the maximum value of the reflectance is at the top part of the stepped profile. According to the reflector showing such the reflectance distribution, since the reflectance in the range of the specific angle within the reflection angle smaller than the direct reflection angle is further increased, an amount of the reflected light is further increased in the distribution in the directions close to the observer's viewpoint. The reflector having higher luminance can be obtained particularly at angles of 0 to 20 degrees which the normal direction of the reflector forms with the main observation direction in the practical viewpoint.

When the reflector of the invention is formed of a base material and a metal film having a plurality of concave parts on the surface, the thickness of the metal film is set in the range of 8 to 20 nm. Thus, the thickness of the metal film is thinner, the light translucency of light from a backlight disposed under the reflector can be enhanced, and the device can be used as a semi-transparent reflective liquid crystal display device exerting excellent properties in the both cases of reflecting light and transmitting light.

Moreover, when the reflector of the invention is formed of a base material having a plurality of concave parts on the surface, the thickness of the base material is set in the range of 8 to 20 nm. Thus, the thickness of the base material is formed thin, and the device can be used as a semi-transparent reflective liquid crystal display device exerting excellent properties as similar to the case where the thickness of the metal film is set in the range of 8 to 20 nm.

In addition, a reflective liquid crystal display device of the invention is characterized by including a liquid crystal cell in which an electrode and an alignment layer are sequentially disposed on an inner surface of one of substrates from a side of the one of the substrates, and an electrode and an alignment layer are sequentially disposed on an inner surface of the other of the substrates from the other of the substrates, the substrates face each other as sandwich a liquid crystal layer,

wherein the reflector is disposed on an outer surface of the one of the substrates or between the one of the substrates and the electrode disposed on the inner surface thereof.

According to the reflective liquid crystal display device in the configuration, when the display is observed from the direction close to the normal direction to the reflective liquid crystal display device, the device can have viewing angle properties that the display is seen brighter than seen from the other viewing angles. Furthermore, when the reflector showing the non-Gaussian distribution type reflectance properties described above is provided, an amount of the reflected light is increased in the distribution in the directions close to the observer's viewpoint, and bright display (screen) can be obtained particularly at angles of 0 to 20 degrees which the normal direction to the liquid crystal display device forms with the main observation direction in the practical viewpoint, allowing a liquid crystal display device excellent in display performance to be realized.

As described above, the reflector according to the invention can show viewing angle properties that when the reflected light having entered the reflector is observed from the direction close to the normal direction to the reflector, it can be seen brighter than seen from the other viewing angles.

Furthermore, the reflective liquid crystal display device of the invention can show viewing angle properties that when the display is seen from the direction close to the normal direction to the device, it can be seen brighter than seen from the other viewing angles.

### BRIEF DESCRIPTION OF THE DRAWINGS

The teachings of the invention can be readily understood by considering the following detailed description in conjunction with the accompanying drawings, in which:

FIG. 1 is a diagram illustrating the structure of partial cross section of a reflective liquid crystal display device of a first embodiment according to the invention;

FIG. 2 is a plan view illustrating one concave part of a reflector provided in the reflective liquid crystal display device shown in FIG. 1;

FIG. 3 is a diagram illustrating a specified longitudinal section of the concave part shown in FIG. 2;

FIG. 4 is a cross section schematically illustrating the effect of one concave part of the reflector provided in the reflective liquid crystal display device shown in FIG. 1;

FIG. 5 is a graph illustrating the relationship between the acceptance angle and the reflectance of the reflector of the embodiment according to the invention and the traditional reflector;

FIG. 6 is a plan view illustrating another example of one concave part of the reflector according to the invention;

FIG. 7 is a plan view illustrating still another example of one concave part of the reflector according to the invention;

FIG. 8 is a plan view illustrating one concave part of a reflector provided in a reflective liquid crystal display device of a second embodiment according to the invention;

FIG. 9 is a diagram illustrating a specified longitudinal section of the concave part shown in FIG. 8;

FIG. 10 is an explanatory diagram illustrating a state of using a liquid crystal display device provided in a cellular phone; and

FIG. 11 is a cross section illustrating the schematic configuration of the traditional reflective liquid crystal display device.

### DESCRIPTION OF THE PREFERRED EMBODIMENT

Hereafter, embodiments of the invention will be described with reference to the drawings, but the invention will not be defined by the embodiments below.

First Embodiment

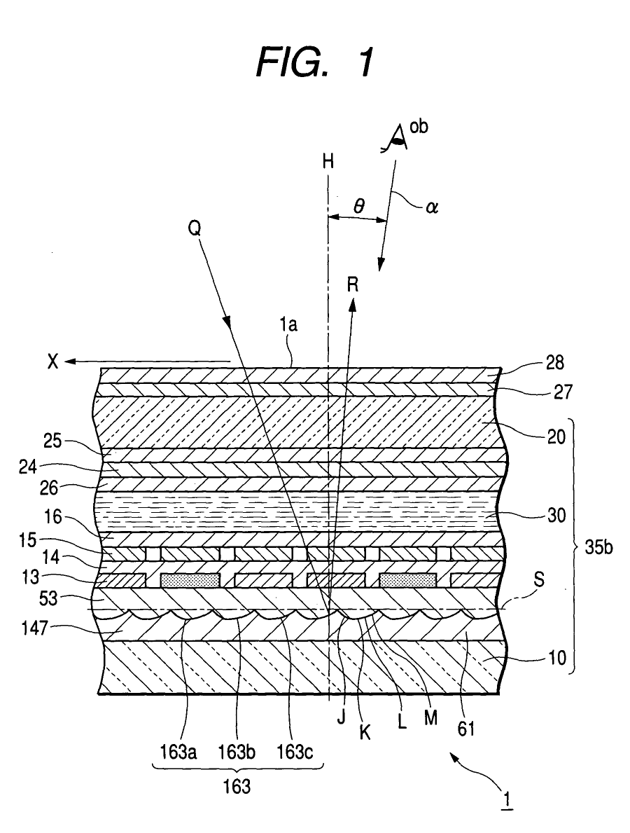

FIG. 1 is a diagram schematically illustrating the structure of partial cross section of a reflective liquid crystal display device of a first embodiment according to the invention.

In FIG. 1, a reflective liquid crystal display device 1 is configured in which a first substrate (one of substrates) 10 and a second substrate (the other of the substrates) 20, both made of transparent glass facing each other as sandwich a liquid crystal layer 30, are bonded in one piece with a sealing material disposed in a ring shape in the periphery of the substrates 10 and 20.

On the liquid crystal layer 30 side of the first substrate 10, a reflector 147, a transparent interposing layer 53, a color filter 13 for color display, an overcoat film (transparent planarization layer) 14 for planarizing bumps and dips due to the color filter 13, a transparent electrode layer 15 for driving the liquid crystal layer 30, and an alignment layer 16 for controlling the alignment of liquid crystal molecules forming the liquid crystal layer 30 are sequentially layered. In addition, on the liquid crystal layer 30 side of the second substrate 20, a transparent electrode layer 25, an overcoat film 24, and an alignment layer 26 are sequentially layered. Furthermore, the transparent electrode layer 15 and the transparent electrode layer 25 are arranged so as to face perpendicularly each other seen in plan, and the reflective liquid crystal display device 1 is formed to be a passive matrix type.

A liquid crystal cell 35b is configured of the first substrate 10, the second substrate 20, and each of component members disposed between the substrates.

On the opposite side of the liquid crystal layer 30 of the second substrate 20 (the outer surface side of the second substrate 20) , a retardation plate 27 and a polarizing plate 28 are layered in this order. The outer side of the polarizing plate 28 is a display surface 1a.

In the reflector 147 provided in the reflective liquid crystal display device 1, concave parts 163a, 163b, 163c and so on (generally called concave parts 163) having light reflectivity are formed irregularly and adjacently on a surface (reference plane) S of a flat plate shaped base material 61 made of aluminium, for example, thereby disposing fine bumps and dips on the surface. The reference plane S of the base material 61 is a plane in parallel with the substrate 10, and a plane including the top parts of the bumps among the fine bumps and dips formed on the surface of the base material 61.

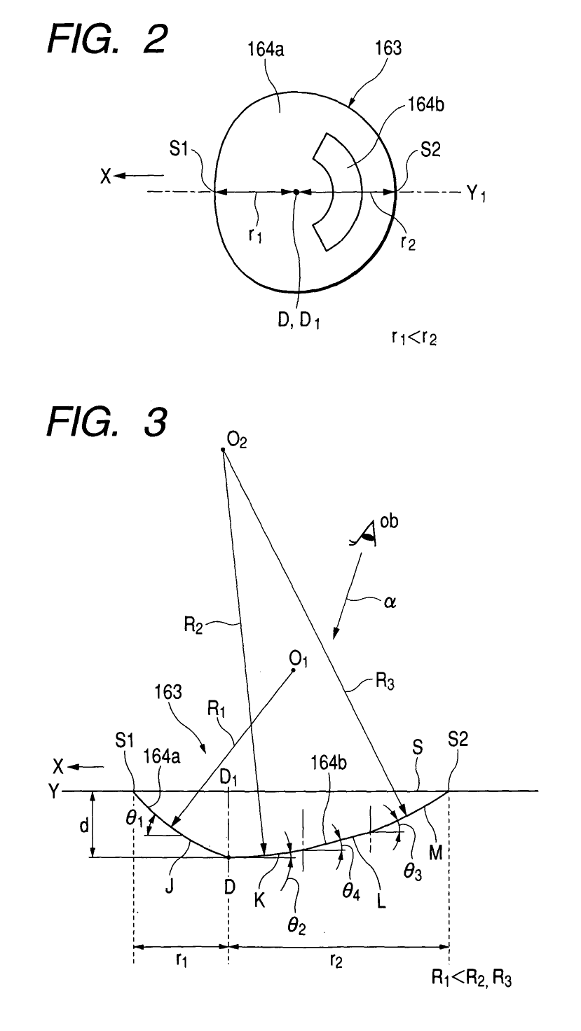

In each of the concave parts 163, the inner surface is formed of a surface that a peripheral curved surface 164a being a part of the aspheric surface in a nearly spoon shape is continued to a plane 164b at the position surrounded by the peripheral curved surface 164a, as FIG. 2 depicts a plan view and FIG. 3 depicts a diagram of specified longitudinal section. As shown in FIG. 2, the plane 164b has an arc shape seen in plan.

Each of the plurality of the concave parts 163 has a specified longitudinal section Y passing through a deepest point D of the concave part 163. As shown in FIG. 3, in the specified longitudinal section Y, the form of the inner surface is formed of a first curve J from one peripheral part S1 to the deepest point D of the concave part 163, a second curve K from the deepest point D to a first straight line L of the concave part 163 continuously to the first curve J, the first straight line L to a third curve M continuously to the second curve K, and the third curve M to an other peripheral part S2 continuously to the first straight line L. The specified longitudinal section Y of the peripheral curved surface 164a has the first curve J, the second curve K, and the third curve M. The specified longitudinal section Y of the plane 164b has the first straight line L. Both of the first curve J and the second curve K have a tilt angle of zero degree to the base material surface S at the deepest point D, joining each other.

As shown in FIG. 2, the arc-shaped plane 164b is formed linesymmetrically to a line (the line along the specified longitudinal section Y) Y₁ passing through the specified longitudinal section Y.

In addition, each of the plurality of the concave parts 163 is formed so as to align the specified longitudinal section Y in the same direction, and to orient the first straight line L in a single direction. In the embodiment, the first straight line L of each of them is formed so as to align in the direction close to the observer's viewpoint ob (the direction opposite to a direction X apart from the observer's viewpoint ob, that is, the direction on the right side of FIGS. 1 and 3) Furthermore, the first curve J of each of them is formed so as to align in the direction X apart from the observer's viewpoint ob. Moreover, the direction on the left side of FIGS. 1 and 3 is the light incident side.

A curvature radius R₂ of the second curve K is formed greater than a curvature radius R₁ of the first curve J. In addition, the curvature radius R₂ of the second curve K is equal to a curvature radius R₃ of the third curve M. Furthermore, the curvature radius of the first curve J changes in the range of 4 μm≦R₁≦120 μm, and the curvature radius of the second curve K changes in the range of 5 μm≦R₂≦140 μm. Moreover, in FIG. 3, θ₁ is the tilt angle of the first curve J, changing in the range of −80°≦θ₁≦0°. θ₂ is the tilt angle of the second curve K, changing in the range of 0°≦θ₂≦3°. θ₃ is the tilt angle of the third curve M, changing in the range of 20°≦θ₃≦35°. θ₄ is the tilt angle of the plane 164b, in other words, it is the tilt angle of the first straight line L, changing in the range of 3°≦θ₄≦20°.

Additionally, when the concave part 163 is seen from the plane direction, a distance r₁ between a normal D₁ deepest point D and the peripheral part S1 is smaller than a distance r₂ between the normal D₁ at the deepest point D and the peripheral part S2.

The distances r₁ and r₂ are determined in accordance with the curvature radii R₁, R₂ and R₃ and the tilt angles θ₁ to θ₄.

Since a depth d of the concave part 163 takes a random (irregular) value at every concave part in the range of 0.1 to 3 μm, moiré patterns are not generated when the reflector 147 is assembled in the reflective liquid crystal display device. Furthermore, a peak concentration of an amount of the reflected light at a particular viewing angle is relaxed, and changes in the amount of the reflected light within sight can be smoothened. It is because the reflectance of the direct reflection angle is too much when the depth of the concave part 163 is below 0.1 μm.

A pitch between the adjacent concave parts 163 takes a random (irregular) value in the range of 2 to 50 μm. This is because there is a problem that light interference color emerges to tint the reflected light when the pitch between the adjacent concave parts 163 supposedly has regularity. Moreover, when the pitch between the adjacent concave parts 163 is below 2 μm, limitations are imposed in fabricating the concave parts of the reflector, significantly prolonging the processing time.

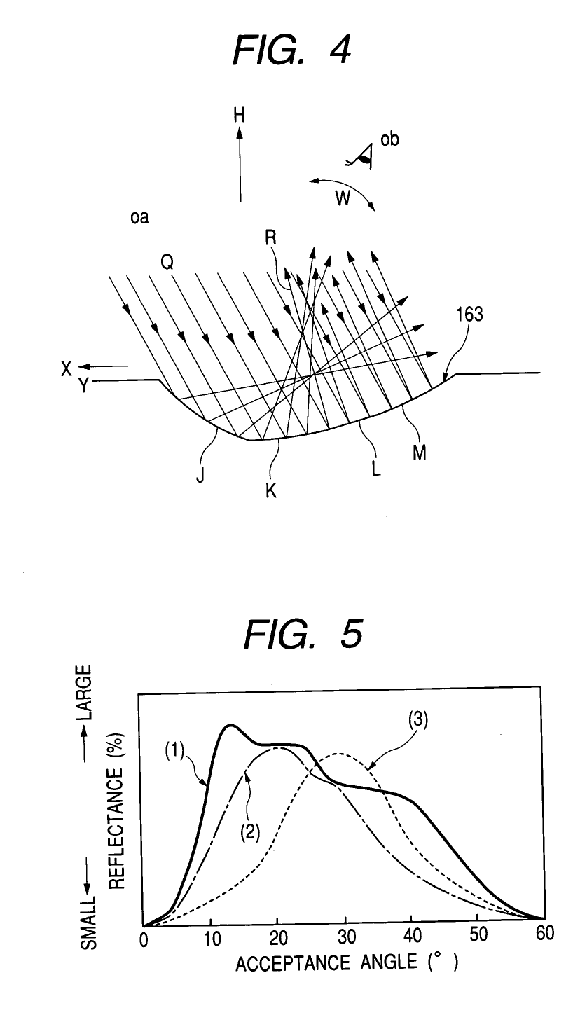

As shown in FIG. 4, when the reflective liquid crystal display device is observed, the observer's viewpoint ob gathers the direction close to the general normal direction H, more specifically, a range W of the normal direction H to an angle of 20 degrees. Therefore, in the embodiment, the plurality of the concave parts 163 having the configuration above is disposed on the surface of the reflector 147 to form (design) to gather more light in the range W. When this is done, outside lights (incident light) Q enter the concave part 163 of the reflector 147 from various direction, and reflect in various directions on the inner surface of the concave part 163 in accordance with the tilt angles of the incident points. Thus, reflected lights R diffuse in the range of a wide viewing angle as a whole, but it is designed to gather more light in the range W in the embodiment. Therefore, when the liquid crystal display device is observed from the direction close to the normal direction H of the device, it can be seen brighter than seen from the other directions.

More specifically, in the reflector 147 of the embodiment, the inner surface of each of the concave part 163 is formed of the surface that the peripheral curved surface 164a being a part of the aspheric surface is continued to the plane 164b at the position surrounded by the peripheral curved surface 164a, and the first curve J of each of them is formed so as to align in the direction apart from the observer's viewpoint ob. Therefore, the reflectance properties are shifted from the direction of direct reflection to the base material surface S. That is, the reflected lights R of the incident lights Q from a direction oa are that a bright display area is shifted in the normal direction H to the base material surface S more than in the direction of direct reflection. Additionally, in the reflector 147 of the embodiment, the second curve K, the first straight line L and the third curve M are aligned in the direction opposite to the first curve J, that is, in the direction close to the observer's viewpoint ob. Thus, as the comprehensive reflectance properties in the specified longitudinal section Y, the reflectance in the direction reflected by the surfaces around the second curve K and the third curve M is increased, and the reflectance in the direction reflected by the surface around the first straight line L is more increased than the magnitude of the reflectance. Therefore, the reflectance properties that the reflected light is properly gathered in a particular direction can be formed.

FIG. 5 shows the relationship between the acceptance angle (°) and the brightness (reflectance) that the outside light Q is irradiated onto the reflector 147 of the first embodiment at an incident angle of 30° (an angle which the perpendicular (normal) H on the reflector 147 forms with the optical axis of the outside light Q irradiated from the opposite side of the observer's viewpoint ob that is observing the display from one side of the perpendicular H) and the observation direction α (acceptance angle) is varied from the position of the normal (acceptance angle of 0°) to an angle of 60°. In FIG. 5, a solid line (1) shows the relationship between the acceptance angle and the reflectance of the reflector 147 of the first embodiment.

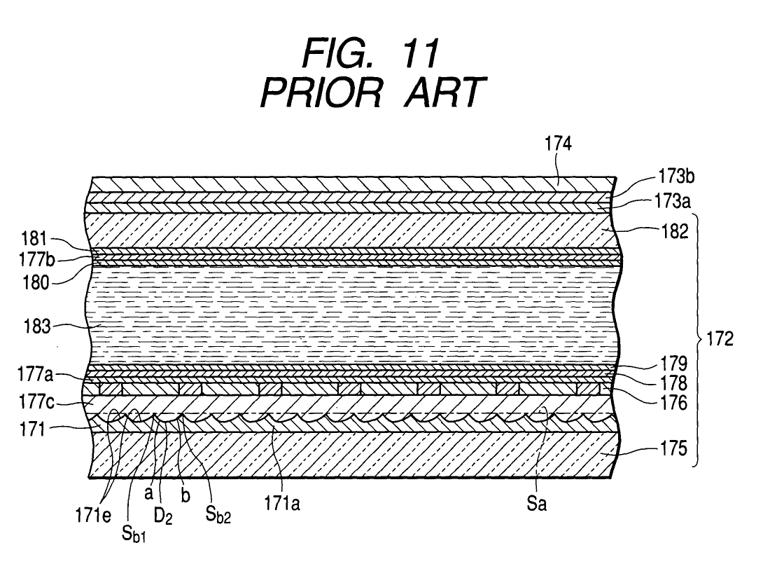

In FIG. 5, the relationship between the acceptance angle and the reflectance of the reflector 171 shown in FIG. 11, which is used before, is depicted by an alternate long and short dash line (2) as Comparative example 1, and the relationship between the acceptance angle and the reflectance of the specular reflector using the traditional Al film is depicted by a dashed line (3) as Comparative example 2.

As apparent from FIG. 5, in the specular reflector of Comparative example 2, the peak of the reflectance is at an acceptance angle of 30° of the direct reflection angle. When the acceptance angle is smaller than an angle of 20°, the reflectance is reduced significantly. Therefore, it is considered that the display seen from the direction of direct reflection is seen bright, whereas the display seen from the other directions is seen dark. Comparative example 2 shows the reflectance higher than that of Comparative example 1 in the acceptance angles from 0 to 30 degrees, because the peak of the reflectance ranges below an angle of 30 degrees of the direct reflection angle in the reflector of Comparative example 1.

Correspondingly, in the reflector 147 of the embodiment, a profile of the graph illustrating the reflectance distribution is stepped, and has non-Gaussian distribution type reflectance properties showing asymmetry to the direct reflection angle of incident light. Additionally, the maximum value of reflectance is around an acceptance angle of about 15° in the range of a reflection angle (in the range of the acceptance angle) smaller than the direct reflection angle (acceptance angle of 30°) of incident light. The maximum value of the reflectance is at the top part of the stepped profile. Furthermore, in the reflector 147 of the embodiment, the reflectance in the range of acceptance angles 0 to about 25° is higher than that of Comparative examples 1 and 2. Therefore, the display can be seen bright in the reflective liquid crystal display device 1 provided with the reflector 147 of the embodiment than in the reflective liquid crystal display device provided with the reflector of Comparative example 1 or Comparative example 2, when the display is observed from the direction close to the normal direction particularly in the practical viewpoint.

Moreover, when the outside light Q enters the reflector 147 of the embodiment from the direction on the left side of FIG. 1 or 3 at an incident angle of 30 degrees, the reflectance at reflection angles greater than a direct reflection angle of 30 degrees is most increased, and the neighboring reflectance is also increased as the peak is in that direction.

The curvature radius R₁ of the first curve J, the curvature radius R₂ of the second curve K, the position of the plane 164b, the tilt angle θ₄ of the first straight line L, and the pitch and the depth d of the plurality of the concave parts 163 are changed to vary the profile of the graph illustrating the reflectance distribution of the reflector 147, thereby allowing the reflector 147 of the embodiment to have desired reflectance properties. Therefore, when observed from the direction close to the normal direction H to the reflector 147, the reflector can be easily controlled to have viewing angle properties that can be seen brighter than seen from the other viewing angles.

Additionally, according to the reflective liquid crystal display device 1 of the embodiment, since it is provided with the reflector 147 of the embodiment, an amount of the reflected light is increased in the distribution in the directions close to the observer's viewpoint ob, bright display (screen) can be obtained particularly at the angle θ of 0 to 20 degrees which the normal direction H to the liquid crystal display device forms with the main observation direction a in the practical viewpoint, and a liquid crystal display device excellent in display performance can be realized. On this account, when the reflective liquid crystal display device of the embodiment is assembled in the display part of portable electronic devices such as a cellular phone and a notebook PC, visibility is particularly excellent.

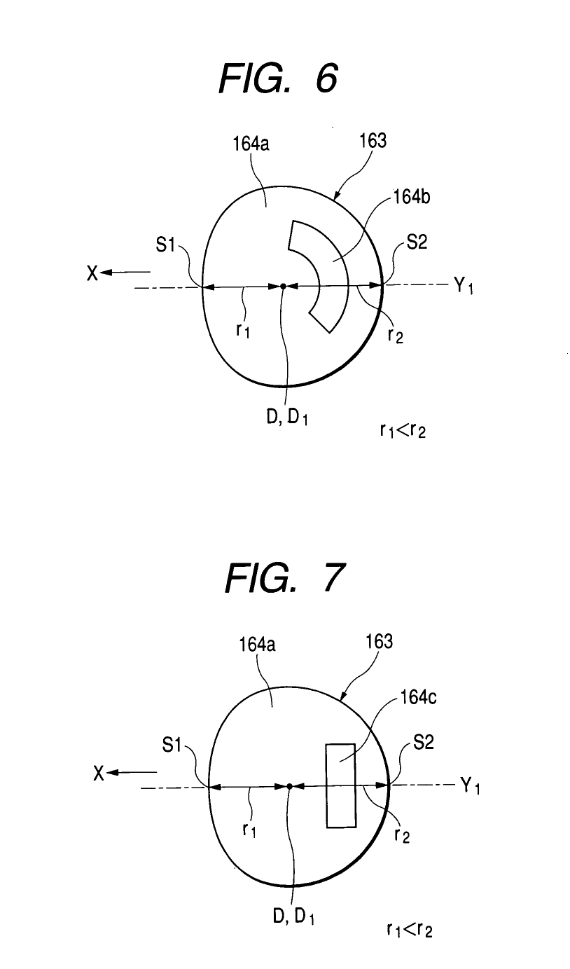

Furthermore, in the reflective liquid crystal display device of the first embodiment, the case is described in which the plane 164b being a part of the inner surface of each of the concave parts 163 formed in the reflector 147 is formed axisymmetrically to the axis Y₁ passing through the specified longitudinal section Y. However, it is acceptable that the plane 164b is formed in the concave part 163 so as to be non-linesymmetric to the line Y₁ passing through the specified longitudinal section Y as shown in FIG. 6. Moreover, as the plurality of the concave parts 163 formed on the surface of the reflector 147, it is acceptable that that having the plane 164b linesymmetric to the line Y₁ passing through the specified longitudinal section Y as shown in FIG. 2 and that having the plane 164b non-linesymmetric to the line Y passing through the specified longitudinal section Y as shown in FIG. 6 are mixed.

In the reflective liquid crystal display device of the first embodiment, the case is described in which the plane 164b being a part of the inner surface of each of the concave parts 163 formed in the reflector 147 has an arc shape seen in plan. However, a plane 164c having a rectangular shape seen in plan as shown in FIG. 7 is acceptable instead of the plane 164b having an arc shape seen in plan. It is acceptable that the plane 164c is formed in the concave part 163 so as to be linesymmetric or non-linesymmetric to the line Y₁ passing through the specified longitudinal section Y. Additionally, as the plurality of the concave parts 163 formed on the surface of the reflector 147, it is acceptable that that having the plane 164c linesymmetric to the line Y₁ passing through the specified longitudinal section Y and that having the plane 164c non-linesymmetric to the line Y₁ passing through the specified longitudinal section Y are mixed. Furthermore, as the plurality of the concave parts 163 formed on the surface of the reflector 147, it is acceptable that that having the plane 164b of an arc shape seen in plan and that having the plane 164c of a rectangular shape seen in plan are mixed.

Second Embodiment

Next, a reflective liquid crystal display device of a second embodiment according to the invention will be described.

The difference of the reflective liquid crystal display device of the second embodiment from the reflective liquid crystal display device 1 of the first embodiment 1 shown in FIG. 1 is in that the form of the plurality of the concave parts formed on the surface of the flat plate shaped base material 61 of the reflector disposed in the liquid crystal cell 35b is different.

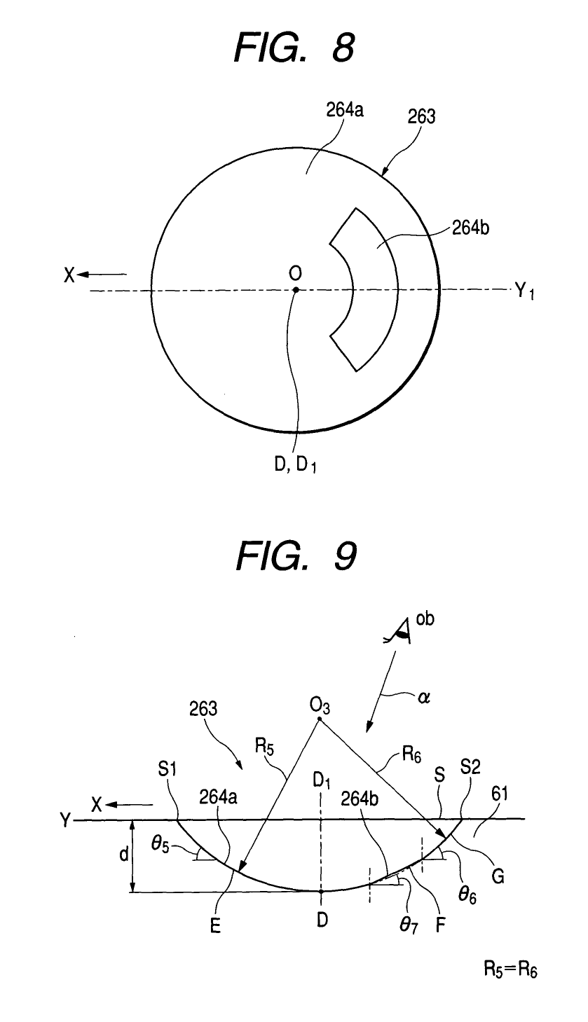

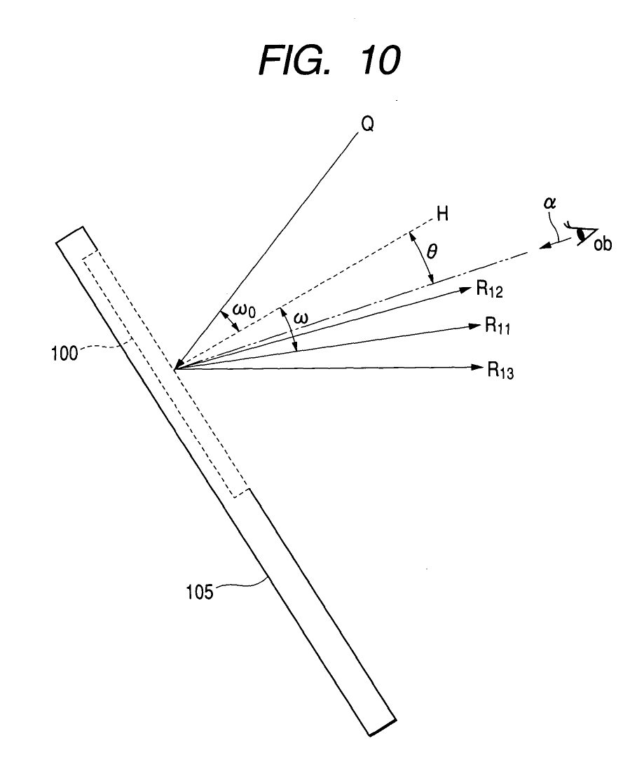

FIG. 8 is a plan view of a concave part 263 formed on the surface of a reflector provided in the reflective liquid crystal display device of the embodiment, and FIG. 9 is a diagram of specified longitudinal section of the concave part 263.

As shown in FIGS. 8 and 9, the inner surface of each of the concave parts 263 is formed of the surface that a peripheral curved surface 264a being a part of spherical surface is continued to a plane 264b at the position surrounded by the peripheral curved surface 264a. As shown in FIG. 8, the plane 264b has an arc shape seen in plan.

Each of the plurality of the concave parts 263 has a specified longitudinal section Y passing through a deepest point D of the concave part 263. As shown in FIG. 8, in the specified longitudinal section Y, the form of the inner surface is formed of a first curve E from one peripheral part S1 of the concave part 263 through the deepest point D to a first straight line F, the first straight line F to a second curve G continuously to the first curve E, and the second curve G to an other peripheral part S2 continuously to the first straight line F. The specified longitudinal section Y of the peripheral curved surface 264a has the first curve E and the second curve G. The specified longitudinal section Y of the plane 264b has the first straight line F. The first curve E has a tilt angle of zero degree to a base material surface S at the deepest point D.

As shown in FIG. 8, the arc-shaped plane 264b is formed linesymmetrically to a line (a line along the specified longitudinal section Y) Y₁ passing through the specified longitudinal section Y.

Additionally, when the reflector provided in the reflective liquid crystal display device of the second embodiment is seen in the plane direction as shown in FIG. 8, a center O of the concave part 263 in the plane direction is matched with the position of the deepest point D.

Furthermore, each of the plurality of the concave parts 263 is formed so as to align the specified longitudinal section Y in the same direction, and to orient the first straight line F in a single direction. In the embodiment, the first straight line F of each of them is formed so as to align in the direction close to the observer's viewpoint ob (the direction opposite to a direction X apart from the observer's viewpoint ob, that is, the direction on the right side of FIGS. 1 and 9). Moreover, the first curve E of each of them is formed so as to align in the direction X apart from the observer's viewpoint ob. In addition, the direction on the left side of FIGS. 1 and 9 is the light incident side.

A curvature radius R₅ of the first curve E is equal to a curvature radius R₆ of the second curve G. Furthermore, a curvature radius of the first curve E is in the range of 5 μm≦R₅≦140 μm.

Moreover, in FIG. 9, θ₅ is the tilt angle of the first curve E, changing in the range of −35°≦θ₅≦3°, and θ₆ is the tilt angle of the second curve G, changing in the range of 20°≦θ₆≦35°. Thus, the tilt angle distribution of the peripheral curved surface 264a is to be set in the range of −35 to +35 degrees. It is because the diffusion angle of the reflected light is spread too much, the reflection intensity is reduced, and bright display cannot be obtained when the tilt angle distribution of the peripheral curved surface 264a is out of the range of −35 to +35 degrees (it is because the diffusion angle of the reflected light becomes an angle of 36 degrees or above in the air, the reflection intensity peak inside the liquid crystal display device is reduced, and the loss in the total reflection is large) . Additionally, in FIG. 9, θ₇ is the tilt angle of the plane 264b, in other words, the tilt angle of the first straight line F, changing in the range of 3°≦θ₇≦20°.

A depth d of the concave part 263 takes a random (irregular) value at every concave part in the range of 0.1 to 3 μm from the same reason as the first embodiment.

The pitch between the adjacent concave parts 263 takes a random (irregular) value in the range of 2 to 50 μm from the same reason as the first embodiment.

According to the reflector provided in the reflective liquid crystal display device of the embodiment, the curvature radii of the first and second curves (the tilt angle distribution of the peripheral curved surface 264b) , the position of the plane 264b, the tilt angle θ₇ of the first straight line F, and the pitch and the depth of d the plurality of the concave parts 263 are changed. Thus, when observed from the direction close to the normal direction to the reflector, the reflector is easily controlled to have viewing angle properties so as to be seen brighter than seen from the other viewing angles.

In addition, according to the reflective liquid crystal display device of the embodiment, the same advantage as that of the reflective liquid crystal display device of the first embodiment can be obtained.

Furthermore, in the first and second embodiments, the reflector 147 is formed separately from the electrode layer 15. However, when the electrode layer 15 itself is formed of the reflector 147 and the electrode layer 15 is formed at the position of the reflector 147, a transparent electrode layer can also serve as the reflector and the layer configuration of the reflective liquid crystal display device is simplified. Moreover, the case is described in which a single retardation plate is disposed between the second substrate 20 and the polarizing plate 28, but the retardation plate can be disposed in plurals.

Additionally, in the embodiments, the liquid crystal display device having the reflector inside is described in which the reflector 147 for reflecting the light having entered from outside is incorporated between the substrate 10 and the substrate 20. However, the liquid crystal display device having the reflector outside can be formed in which the reflector 147 is disposed outside the two substrates sandwiching the liquid crystal layer.

Furthermore, in the embodiments, the case is described in which the reflector 147 has the plurality of the concave parts 163 on the surface of the base material 61, the concave parts 163 has light reflectivity of the configuration above. However, as the reflector, it is acceptable that that having the plurality of the concave parts 163 of the configuration above on the surface of a metal film formed on the base material. In this case, organic films such as acrylic resist can be used as the base material, and metal films formed of those having high reflectance such as Al and Ag can be used as the metal material.

Moreover, in the embodiments, the case is described in which the invention is adapted to the reflective liquid crystal display device, but it can also be adapted to the semitransparent reflective liquid crystal display device. In this case, the thickness of the base material 61 of the reflector 147 is set in the range of 8 to 20 nm (80 to 200 angstroms). Alternatively, when the reflector is formed of the base material and the metal film formed with a plurality of concave parts on the surface, it is fine that the thickness of the metal film is set in the range of 80 to 200 nm (800 to 2000 angstroms), fine openings are formed in the metal film, and a backlight as a light source for transmissive display is disposed on the outer surface side of the first substrate 10. In this case, it is fine to dispose a second polarizing plate between the backlight and the liquid crystal panel 35b.

In addition, in the embodiments, the case is described in which the reflective liquid crystal display device of the invention is adapted to the passive matrix liquid crystal display device, but the invention is not defined to this, which can also be adapted to the active matrix liquid crystal display device. In this case, it is fine that the reflector 147 described above is disposed above or under pixel electrodes forming pixels, for example.

What is claimed is:

1. A reflector comprising a plurality of concave parts having light reflectivity formed on a metal film formed on a base material or on a surface of the base material,
wherein an inner surface of the concave part is formed of a surface that a peripheral curved surface being a part of aspheric surface is continued to a plane at a position surrounded by the peripheral curved surface,
each of the plurality of the concave parts has a specified longitudinal section passing through a deepest point of the concave part,
a form of an inner surface of the specified longitudinal section is formed of a first curve from one peripheral part of the concave part to a deepest point thereof, a second curve from the deepest point of the concave part to a first straight line continuously to the first curve, the first straight line to a third curve continuously to the second curve, and the third curve to an other peripheral part continuously to the first straight line,
a curvature radius of the second curve is greater than a curvature radius of the first curve, and
curvature radii of the second curve and the third curve are equal.

2. A reflector comprising a plurality of concave parts having light reflectivity formed on a metal film formed on a base material or on a surface of the base material,
wherein an inner surface of the concave part is formed of a surface that a peripheral curved surface being a part of spherical surface is continued to a plane at a position surrounded by the peripheral curved surface,
each of the plurality of the concave parts has a specified longitudinal section passing through a deepest point of the concave part,
a form of an inner surface of the specified longitudinal section is formed of a first curve from one peripheral part of the concave part through a deepest point thereof to a first straight line, the first straight line to a second curve continuously to the first curve, and the second curve to an other peripheral part continuously to the first straight line, and
curvature radii of the first curve and the second curve are equal.

3. The reflector according to claim 1 or 2, wherein the form of the plane is a rectangular shape or arc shape seen in plan.

4. The reflector according to claim 1 or 2, wherein the plane is formed inside the concave part so as to be linesymmetric to an line passing through the specified longitudinal section.

5. The reflector according to claim 1 or 2, wherein the plane is formed inside the concave part so as to be non-linesymmetric to an line passing through the specified longitudinal section.

6. The reflector according to claim 1 or 2, wherein a depth of the concave part is formed irregularly in a range of 0.1 to 3 μm, and a pitch between the adjacent concave parts is disposed irregularly in a range of 2 to 50 μm in the plurality of the concave parts.

7. The reflector according to claim 2, wherein the peripheral curved surface being a part of the spherical surface is formed to have a tilt angle distribution in a range of −35 to +35 degrees.

8. The reflector according to claim 1 or 2, wherein the reflector has a reflectance distribution asymmetric to a direct reflection angle of incident light, and also has a non-Gaussian distribution type reflectance property where a maximum value of reflectance is in a range of a reflection angle smaller than the direct reflection angle of the incident light.

9. The reflector according to claim 8, wherein a profile of a graph illustrating the reflectance distribution of the reflector is stepped, and the maximum value of the reflectance is at the top part of the stepped profile.

10. The reflector according to claim 1 or 2, wherein a thickness of the base material or the metal film of the reflector ranges from 8 to 20 nm.

11. A reflective liquid crystal display device comprising a liquid crystal cell in which an electrode and an alignment layer are sequentially disposed on an inner surface of one of substrates from a side of the one of the substrates, and an electrode and an alignment layer are sequentially disposed on an inner surface of the other of the substrates from the other of the substrates, the substrates face each other as sandwich a liquid crystal layer,
wherein the reflector according to claim 1 or 2 is disposed on an outer surface of the one of the substrates or between the one of the substrates and the electrode disposed on the inner surface thereof.
